(19) United States
(12) Patent Application Publication
(10) Pub. No.: US 2008/0140585 A1
(43) Pub. Date: Jun. 12, 2008

(54) Method for improving performance of constant leverage assets based on approximate payoffs

(76) Inventor: Ronald Hylton, New York, NY (US)

Correspondence Address: MINTZ LEVIN COHN FERRIS GLOVSKY & POPEO;ATTN: PATENT INTAKE CUSTOMER NO. 35437, ONE FINANCIAL CENTER, BOSTON, MA, 02111, US

(21) Appl. No.: 11/825,061

(22) Filed: Jul. 2, 2007

Related U.S. Application Data
(60) Provisional application No. 60/817,681, filed on Jun. 30, 2006.

(51) Int. Cl. G06Q 40/00

(52) U.S. Cl. 705/36 R

(57) ABSTRACT

A method is applied for improving performance of constant leverage assets (CLAs) by establishing a CLA approximated portfolio of assets having investment options in relation to an original portfolio. The investment options are allocated to predetermined increments whereby they are subsequently monitored in view of the CLA approximated portfolio. The performance of the CLA approximated portfolio is evaluated based on the monitored leverage in comparison with a desired level of leverage, and analyzed in view of underlier trends correlated to options exchanges. Readjustment occurs by incorporating new strikes upon the determination of the underlier trends fluctuating up or down, and thereby altering an approximate payoff function which ultimately varies the leverage of the CLA approximated portfolio to a level marginal to the desired level.

### REFERENCE TO RELATED APPLICATIONS

The present application is based upon and claims priority from U.S. Provisional Patent Ser. No. 60/817,681, filed on Jun. 30, 2006, the entire contents of which are herein incorporated herein by reference.

### FIELD OF THE INVENTION

Embodiments of the present invention relate to a method for evaluating the performance of an investment under particular market scenarios, and more particularly, to a method for monitoring and altering the approximate payoff under certain conditions pertaining to target investment performance.

### BACKGROUND OF THE INVENTION

Constant Leverage Assets (CLAs) are a type of financial product, based generally on specific payoff formulas. In some cases, it is not possible or desirable to achieve the exact payoff function at the time the product is first issued or otherwise made available to investors, and as a consequence, the performance of the investment may deviate from the desired constant leverage performance if, for example, the underlying benchmark moves too far from the value it had when the approximate payoff was originally established.

In some cases it is not possible nor desirable to achieve the exact payoff function when the product is initially made available to investors, rather an approximate payoff may be used that comes close to providing the desired investment characteristics under many market scenarios; however, some other market scenarios may have significant deviations from the desired performance.

An important consideration for every investor is the credit risk he incurs when buying an investment product. A common way of minimizing this risk is to buy investment products that are listed on an exchange and whose credit performance is guaranteed by a well-known financial institution with a very high credit-worthiness, for example, the Options Clearing Corporation.

Currently, constant leverage assets are not available in an exchange-traded highly credit-worthy form. However, it may be possible to construct a portfolio of ordinary options on the appropriate underlier which do have a credit guarantee from, for example, the Options Clearing Corporation and which, over a wide range of market scenarios, will closely approximate the desired constant leverage performance. However, the range of strikes available for this underlier on an exchange at any time is limited and the approximation will only be good as long as likely future values of the underlier at option expiration stay within the range of strikes incorporated into the approximating portfolio.

Thus, it is desirable to provide a method to improve the performance of an investment by monitoring how well the approximate payoff is producing the desired performance and possibly altering the approximate payoff to maintain performance closer to that of the desired performance.

### SUMMARY OF THE INVENTION

Embodiments of the present invention relate to monitoring and altering the approximate payoff under certain conditions pertaining to target investment performance.

In accordance with some embodiments of the present invention, a method for improving performance of constant leverage assets (CLAs) is provided. The method includes establishing a CLA approximated portfolio of assets having investment options in relation to an original portfolio, allocating the investment options to predetermined increments, monitoring leverage of the CLA approximated portfolio, determining performance of the CLA approximated portfolio based on the monitored leverage in comparison with a target leverage, and analyzing underlier trends correlated to options exchanges. The CLA approximated portfolio includes at least one benchmark asset.

In an embodiment of the present invention, the method for improving performance of CLAs further details introducing new strikes upon the determination of the underlier trends fluctuating up or down, readjusting the CLA approximated portfolio to incorporate the new strikes, altering an approximate payoff function, and varying the leverage of the CLA approximated portfolio to a level marginal to the desired level.

In an embodiment of the present invention, the method for improving performance of CLAs further details introducing the new strikes to fit in with original strikes from the original portfolio.

The foregoing and other features, aspects, and advantages of the present invention will be more apparent from the following detailed description, which illustrates exemplary embodiments of the present invention.

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 relates to a corresponding payoff as shown via payoff vs. spot in accordance with some embodiments of the present invention.

FIG. 2 relates to a corresponding leverage at the time of creation in accordance with some embodiments of the present invention.

FIG. 3 relates to a method for improving performance of constant leverage assets (CLAs) according to some embodiments of the present invention.

### DETAILED DESCRIPTION OF THE INVENTION

The following description focuses on methods for monitoring and altering the approximate payoff under certain market conditions pertaining to investment performance.

Within certain market scenarios, under which constant leverage not being closely approximated becomes more likely, underlier trends that may very strongly fluctuate or vary up or down have a significant probability of falling outside a range of strikes used in an original portfolio. According to some embodiments of the present invention, under this situation the leverage may start to deviate significantly from the desired level, a problem that can be monitored both by using financial models and by observing the actual performance of the approximating portfolio. The varying types of financial models would be recognized by one of ordinary skill in the art, an example being the Black-Scholes model, which would be implemented in the method for improving performance of CLAs.

According to some embodiments of the present invention, as the underlier trends shift up or down, it is likely that the options exchanges will introduce new strikes that “stay ahead” of the underlier. By readjusting the approximating portfolio to incorporate these new strikes (and thereby altering the approximate payoff function), the leverage of the approximating portfolio can be brought back to a level closer to the desired level. It may also happen that strikes are introduced that “fill in” between the strikes that were previously available and that incorporating these new strikes will improve the performance of the approximating portfolio. This is particularly true when liquidity constraints have limited the number of options used at coarsely spaced strikes in the original portfolio and more finely spaced strikes have been introduced between the coarse strikes such that liquidity constraints are no longer in effect when the new strikes are used, or the liquidity constraints have less of an impact on portfolio performance when the new strikes are incorporated in the portfolio.

It may happen that this readjustment entails removing from the portfolio some previously incorporated strikes that are now too far from the money to be useful in keeping leverage constant; this may actually worsen the match between the approximate and exact payoff functions under some scenarios, but these scenarios are now so unlikely that they won't affect the leverage value. According to some embodiments, the aforementioned procedure may be performed multiple times until a preferred result occurs.

Constant Leverage Assets (CLAs) correspond to products that are based on specific curved payoff functions tied to one or more underliers that possess the desired investment properties due to the mathematical form of the payoff function, as described in commonly-owned U.S. application Ser. No. 10/421,261, filed Apr. 23, 2003, and U.S. application Ser. No. 10/877,055, filed Jun. 24, 2004, which are hereby incorporated by reference herein in their entirety.

In accordance with some embodiments of the present invention, as an example, a nominal $100,000,000 CLA with a leverage of 2 is created, with a 1-year expiry on benchmark XYZ. At the time of creation, the benchmark value is 100 and option strikes are available from 60 to 140, in increments of 5. Assume XYZ volatility is 20%, XYZ dividend yield is 1%, and interest rates are 5%. The initial approximating portfolio consists of calls and a forward contract struck at 0 and is given in Table 1 below, where it is assumed option and forward contracts are available in unit size increments, which may be predetermined. The portfolio may also consist of puts, along with other types of market activities, which would be recognized by one of ordinary skill in the art e.g., shorting of securities and purchasing securities on margin to create returns in different market conditions. The portfolio fit also includes liquidity limits on the number of options available at each strike, which in this case, amounted to no more than 233098 options at any strike.

TABLE 1
Initial portfolio

| | | |
|---|---|---|
| 233098 | 140 | call |
| 95196 | 135 | call |
| 91594 | 130 | call |
| 93740 | 125 | call |
| 92882 | 120 | call |
| 94168 | 115 | call |
| 89884 | 110 | call |
| 105733 | 105 | call |
| 74460 | 100 | call |
| 100183 | 95 | call |
| 112085 | 90 | call |
| 10913 | 85 | call |
| 75012 | 80 | call |
| 233098 | 75 | call |
| 233098 | 70 | call |
| 233098 | 65 | call |
| 233098 | 60 | call |
| 596509 | 0 | fwd |

TABLE 2
Adjusted portfolio

| | | |
|---|---|---|
| 233098 | 165 | call |
| 233098 | 160 | call |
| 0 | 155 | call |
| 104851 | 150 | call |
| 89715 | 145 | call |
| 95456 | 140 | call |
| 96432 | 135 | call |
| 98488 | 130 | call |
| 100289 | 125 | call |
| 100849 | 120 | call |
| 100325 | 115 | call |
| 98467 | 110 | call |
| 94889 | 105 | call |
| 93427 | 100 | call |
| 83707 | 95 | call |
| 108756 | 90 | call |
| 10770 | 85 | call |
| 63429 | 80 | call |
| 233098 | 75 | call |
| 233098 | 70 | call |
| 233098 | 65 | call |
| 233098 | 60 | call |
| 596379 | 0 | fwd |

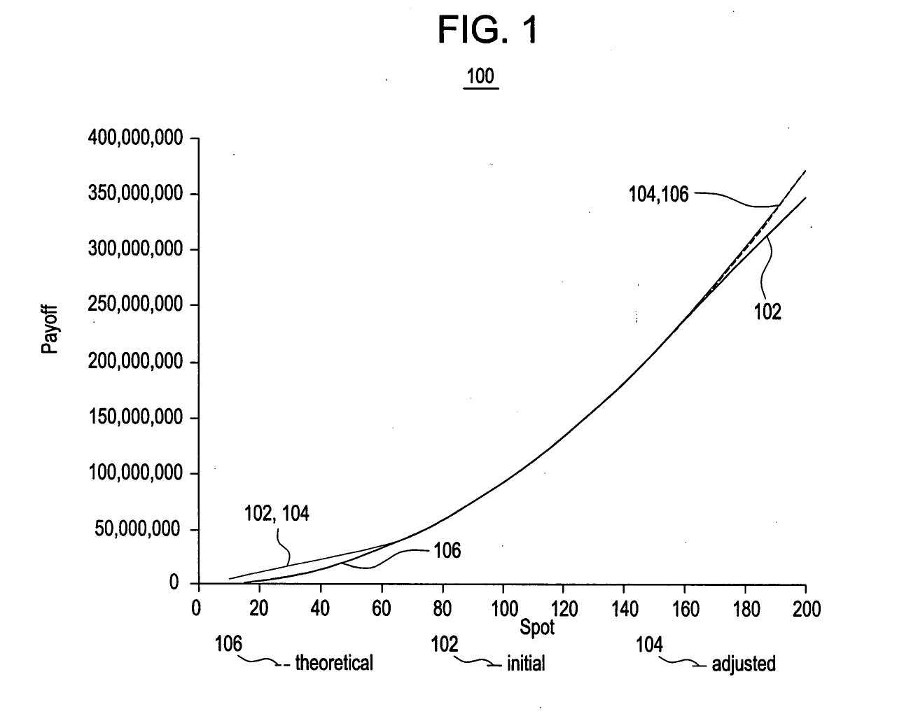

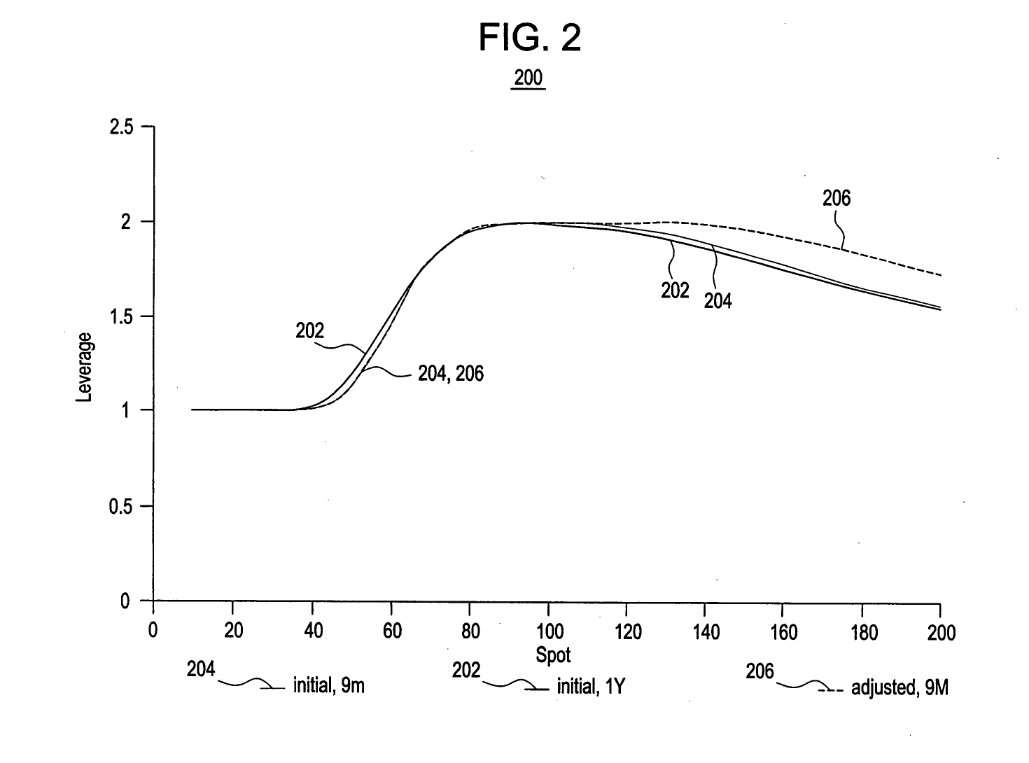

The corresponding payoff is shown below in FIG. 1 (payoff vs. spot) 100 as “initial” 102 and the corresponding leverage at the time of creation is shown in FIG. 2 (leverage vs. spot) 200 as “initial, 1Y” 202.

Now suppose it is 3 months later (9M remaining to expiry) and the benchmark is at 125. The value of the portfolio is now $153,114,842. The corresponding leverage is shown in FIG. 2 (leverage vs. spot) as “initial, 9M” 204 and the leverage value at 125 is 1.96. As can be seen, this is starting to deviate significantly from 2 and if spot keeps rising, the leverage will fall further, so an adjustment may be necessary.

At this time, new option strikes are available from 145 to 160 in increments of 5. The adjusted portfolio incorporating these strikes is given in Table 2 and has the payoff shown in FIG. 1 as “adjusted” 104, a much better match to the theoretical payoff 106 at high spot values. The adjusted portfolio leverage is shown in FIG. 2 as “adjusted, 9M” 206 and is much closer to 2 for spot values above 100. The transaction costs to effect the adjustment are only $50,000, so the adjustment is made.

Notice that the number of options at the more extreme strikes is limited to 233098 due to a liquidity constraint in the example. If new strikes are introduced with a finer spacing than originally available (for example, new strikes at 62.5, 67.5, 72.5, and 162.5) then incorporating these new strikes in the portfolio would significantly improve the match between the approximate portfolio payoff and the theoretical payoff because of the additional liquidity of up to 233098 options at each of the new strikes as well as the improvement in smoothness of the approximate payoff due to the availability of more finely spaced strikes.

According to an alternative embodiment of the present invention, new strikes may be introduced despite minimal movement of the underlier. This occurs as you get close to option expiry and the existing or original strikes are too coarsely spaced given the shorter time to expiry; therefore, exchanges institute new strikes to fill in between some of the existing strikes.

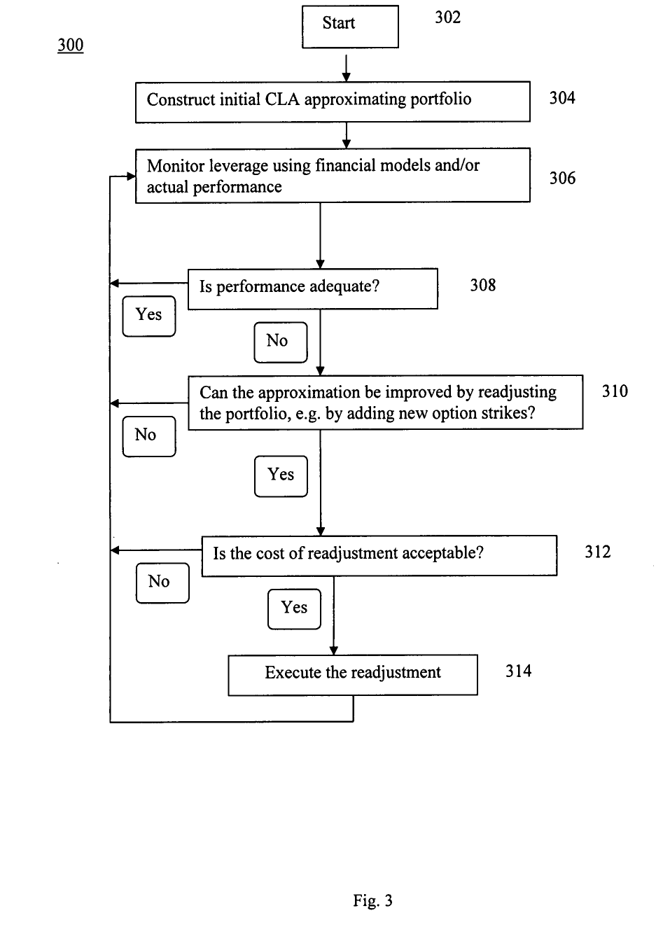

FIG. 3 relates to a method for improving performance of constant leverage assets (CLAs) 300, whereby, according to some embodiments of the present invention, the above investment scenario can be generalized. The process 300 starts at step 302 and proceeds to constructing an initial CLA approximating portfolio where an approximate payoff function has been employed to approximate a CLA 304. The actual leverage can be monitored using financial models and/or actual investment performance 306. If the approximate leverage deviates too far from the target leverage 308, the feasibility of modifying the approximate payoff to more closely provide the target leverage can be examined and, if feasible and worthwhile, implemented 310. If the performance is deemed accurate 308, the process 300 reiterates step 306 of monitoring the leverage.

Feasibility may be determined by such factors as whether new option strikes or other financial instruments are available, the cost of making the adjustments, the acceptability of these adjustments to investors, and contractual, legal, or regulatory constraints 310. If the approximation is determined to not need improvement, the process 300 reiterates step 306 of continually monitoring the leverage. If improvement is deemed necessary via readjusting the portfolio 310, the process 300 proceeds to step 312, whereby the cost of readjustment is assessed. If the cost is not deemed acceptable in step 312, the process returns to step 306 in which further monitoring of the leverage occurs. Upon a determination of acceptable cost of readjustment 312, the process 300 then executes the readjustment 314. Furthermore, after readjustment is executed in step 314, the process 300 returns back to step 306 for monitoring the leverage using financial models and/or actual performance analysis.

According to some embodiments of the present invention, the adjustments to be considered will tend to bring the approximate payoff function into closer agreement with the exact payoff function under likely market scenarios but may in some cases worsen the match between the approximate and exact payoff functions for market scenarios that are unlikely at the time the adjustments are made 310.

The above process may be repeated multiple times as necessary to maintain leverage within desired bounds as seen in steps 314 and subsequent step 306.

While the example given above is for a single-underlier CLA, the same method can be applied in the multiple-underlier case.

Options are commonly available with one of two exercise styles, European or American. European options can only be exercised at maturity and are preferred when approximating a CLA since CLAs also have a fixed maturity (although they can be “rolled” prior to maturity to effect an indefinite maturity). In some cases though only American options (which can be exercised at maturity or before) are available so the approximating portfolio must use them. It is sometimes optimal for the owner to exercise an American option prior to maturity (typically to capture underlier dividends on a call or interest on the strike amount for a put). Therefore the financial performance of portfolios containing bought (or “long”) American options may be improved by monitoring the individual options for optimal early exercise using standard techniques and doing so when appropriate. Generally such options will be so far in the money that early exercise will not cause a significant deterioration in the match between approximate and theoretical payoffs except under very unlikely market scenarios.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The applicant reserves the right to pursue such inventions in later claims.

What is claimed is:

1. A method for improving performance of constant leverage assets (CLAs), comprising:
establishing a CLA approximated portfolio of assets having investment options in relation to an original portfolio,
wherein the CLA approximated portfolio includes at least one benchmark asset;
allocating the investment options to predetermined increments;
monitoring leverage of the CLA approximated portfolio;
determining performance of the CLA approximated portfolio based on the monitored leverage in comparison with a target leverage; and
analyzing underlier trends correlated to options exchanges.

2. The method of claim 1, further comprising:
introducing new strikes upon the determination of the underlier trends fluctuating up or down;
readjusting the CLA approximated portfolio to incorporate the new strikes;
altering an approximate payoff function; and
varying the leverage of the CLA approximated portfolio to a level marginal to the desired level.

3. The method of claim 2, further comprising:
introducing the new strikes to fit in with original strikes from the original portfolio.

4. The method of claim 3, wherein liquidity constraints have limited a number of options pertaining to the original portfolio, and wherein the introducing of the new strikes between the original strikes.

5. The method of claim 4, wherein the new strikes render the original strikes liquidity constraints ineffective, and wherein the new strikes improve the match between an approximated portfolio payoff and a theoretical payoff due to additional liquidity and availability of the new strikes, which are more finely spaced than the original strikes, that are coarsely spaced.

6. The method of claim 4, wherein the new strikes reduce the impact of the liquidity constraints on the CLA approximated portfolio.

7. The method of claim 5, wherein at least one of the original strikes is removed from the CLA approximated portfolio, wherein the original strikes provide no basis for keeping the leverage constant.

8. The method of claim 1, wherein the CLA corresponds to products that are based on specific curved payoff functions tied to one or more underliers that possess desired investment properties.

9. The method of claim 1, wherein the investment options comprise at least one call option, put option, or forward contract.

10. The method of claim 2 wherein the readjustment of the CLA approximated portfolio is repeated as necessary to maintain the leverage with desired bounds.

11. The method of claim 2 wherein the readjustment is applied to multiple-underlier assets.

12. The method of claim 2 wherein the CLA approximated portfolio is adjusted based on a financial model.

13. The method of claim 2 wherein the investment options are of either American style or European style.

14. The method of claim 13, wherein the European style investment options are exercised at maturity for the CLA approximated portfolio.

15. The method of claim 13, wherein the American style investment options are exercised using standard techniques.
